(19) United States
(12) Patent Application Publication
(10) Pub. No.: US 2016/0308991 A1
(43) Pub. Date: Oct. 20, 2016

(54) ANALYTICS SYSTEM ARCHITECTURE

(71) Applicant: Microsoft Technology Licensing, LLC, Redmond, WA (US)

(72) Inventor: Dmitrijs Rutko, Redmond, WA (US)

(21) Appl. No.: 14/792,228

(22) Filed: Jul. 6, 2015

(30) Foreign Application Priority Data
Apr. 14, 2015 (GB) 1506327.4

(51) Int. Cl. H04L 29/08

(52) U.S. Cl. CPC H04L 67/26; H04L 67/1097

(57) ABSTRACT

An analytics system for aggregating data in a distributed computing platform, the analytics system comprising: a plurality of worker roles configured to receive and process information from client applications, each worker role having access to an associated memory for storing the information from client applications, wherein each worker role is further configured to push the stored information from client applications stored within the associated memory to an analytics role; at least one analytics role configured to receive the pushed stored information and furthermore configured to receive and respond to a request based on the pushed stored information.

### RELATED APPLICATION

This application claims priority under 35 USC 119 or 365 to Great Britain Application No. 1506327.4 filed Apr. 14, 2015, the disclosure of which is incorporated in its entirety.

### BACKGROUND

It is known that distributed computer platforms and cloud-based applications (for example Azure applications) can become a place where user data can be collected from various clients. An analytics system may request such data and the data can be aggregated and forwarded for analysis. An analytics server can for example request aggregated data from a user data store and perform analytical processing to determine various analytical values which for example may be used to improve the experience for the various clients in network optimisation.

In the following examples the cloud-based application is one which is involved in aggregating data from a communications system. Conventional communications systems allow a user of a device (endpoint), such as a personal computer or mobile device, to conduct voice or video calls with one or more other endpoints over a packet-based computer network such as the Internet. A user device as used by a user may execute a communication client for use in conducting such calls. Frequently, communication of call data by endpoints is effected by the endpoints adhering to an agreed communication protocol. One example of this is the Session Initiation Protocol (SIP). In broad terms, SIP dictates that calls be negotiated in accordance with an endpoint-to-endpoint request-response-based transaction paradigm in which (among other things) the call is progressed from an initial unconnected state to a state in which real-time media can flow between endpoints by SIP user agents—such as SIP user agent which forms part of the client software executed at endpoint—transmitting a sequence of request messages to other user agents of other endpoints and receiving respective response messages in return, with maintenance and eventual termination of the call being similarly affected. Each user agent maintains a state machine for the duration of the call which is used to track current call state. The state machines are suitably updated upon transmission of salient requests and receipt of salient responses.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

Also disclosed is an analytics system for aggregating data in a distributed computing platform, the analytics system comprising: a plurality of worker roles configured to receive and process information from client applications, each worker role having access to an associated memory for storing the information from client applications, wherein each worker role is further configured to push the stored information from client applications stored within the associated memory to an analytics role; at least one analytics role configured to receive the pushed stored information and furthermore configured to receive and respond to a request based on the pushed stored information.

Also disclosed is an apparatus comprising: at least one processor; and a memory comprising worker role code, the worker code, when executed on the at least one processor, causes the apparatus to: receive and process information from client applications; access an associated memory for storing the information from client applications; and push the stored information from client applications stored within the associated memory to an analytics role; and a memory comprising analytics role code, the analytics role code, when executed on the at least one processor, causes the apparatus to receive the pushed stored information; and receive and respond to a request based on the pushed stored information.

Also disclosed is a method for aggregating data in a distributed computing platform, the method comprising: receiving and processing information from client applications at a plurality of worker roles; storing the information from client applications on an associated memory; pushing the stored information from client applications stored within the associated memory to an analytics role; receiving the pushed stored information at at least one analytics role; and receiving and responding to a request based on the pushed stored information.

Also disclosed are computer program products configured to implement any of the disclosed methods and/or communication systems and/or agents.

### BRIEF DESCRIPTION OF FIGURES

To aid understanding of the disclosed subject matter and to show how the same may be put into effect, reference will now be made, by way of example, to the following drawings in which:

FIG. 1 is a schematic illustration of an analytics system for monitoring a communication system;

FIG. 2 is a schematic illustration of a user device for the communications system as shown in FIG. 1;

FIG. 3 is a schematic overview of a distributed computer platform architecture;

FIG. 4 is a schematic illustration of a pull analytics architecture;

FIG. 5 is a schematic illustration of the methods of pulling data for analytic processing;

FIG. 6 is a schematic illustration of a push analytics architecture according to some embodiments; and

FIG. 7 is a schematic illustration of the methods of pushing data for analytic processing according to some embodiments.

### DETAILED DESCRIPTION

The following examples describe the operation of an analytics system for implementation within a communications system. However it is understood that the analytics system may be implemented as any data collection system within a “distributed platform” otherwise referred to as a “cloud platform” or simply a “cloud”.

The use of such an analytics system for monitoring a communications system may be for example to determine in near real-time a network failure and identify where the network failure has occurred. This information may then be used to enable any network routing or planning operations to re-route data.

Typically an analytics system comprises a highly scalable solution with multiple (dozens or hundreds) of working instances configured to collect the user data from clients. In cloud-based applications such as Azure™ an analytics system comprises an additional role which recovers all information/statistics from other internal working roles, accumulates and then processes this data. Typically this is implemented by a standard pull approach where database locks are introduced in order to synchronise updated data. In such a manner the analytics system is unable to produce near real time analysis of the system.

Furthermore there is a potential loss of data as the data is not stored persistently in individual instances but only stored for some period of time (the time period being configurable) and then erased. Due to the low scalability and performance of the existing approach it is possible that not all data from individual instances will be pulled completely to the analytics system or entity in time and thus will be lost.

The concept such as described in further detail hereafter is to design a worker role and analytic role such that it is suitable for operating a push approach. Such configurations avoid database (DB) locking in each instance and improves scalability and provides near real time data analytics for systems such as used in Azure™ and other cloud or distributed based systems.

As used herein, a “distributed platform” (“cloud”) is a computing platform, accessible via a network (e.g. the Internet), which includes a distributed computer system comprised of multiple networked computer devices and system software running thereon, the computer system providing a (potentially very large) pool of physical computing resources (such as physical processing resources and physical memory resources, volatile and/or non-volatile), and the system software being configured to partition this underlying physical resource pool by implementing multiple independent, software-realized (or “virtual”), resource-limited computer systems each having their own respective computer architecture (which may be different from that of the underlying physical computer system on which they are running) Each of these virtual computer systems is allocated by the system software (and can thus make use of) a predetermined portion of the total available physical resources, that portion having a size which is substantially independent from any other virtual computer systems of that platform. At least some of these virtual computer systems are configured to provide a runtime environment for application code, the code application being executed within that virtual computer system e.g. on one or more virtual processors having a respective instruction set architecture (which may be different from that of any physical processor(s) on which the virtual computer system is running). These or other such virtual computer systems may be configured as data access means (e.g. being configured as a database server or similar), configured to provide access to physical memory resources accessible by that data access means, by which application code can read data from, and write data to, those physical memory resources.

This pooling of physical computer resources, and partitioning of that pool through virtualization act to decouple hardware and software considerations due to a virtualization layer (realized by the system software of the platform) providing separation of physical computer resources (e.g. available physical processor clock cycles and physical bits of memory) from ‘virtual’ resources—that is, resources actually be seen within each virtual computer system. Physical resources of the underlying hardware can be augmented by way of addition of new physical network computer devices, or upgrading of existing physical networked computer and the only considerations that need to be made in terms of legacy compatibility are of ensuring that the upgraded physical computer systems can still run the same generic virtual machines (i.e. without any consideration of what operating systems or application code are going to be run on those virtual machines). Similarly, a system designer can design systems (possibly extremely complex systems with many components), and develop code in relation thereto, for implementation on the cloud platform free from physical hardware considerations (such as ordering, deploying and housing physical servers etc.)—the system designer need only consider consumptions of computer resources in terms of resource limitations of virtual computer systems (not resource limitations of the underlying hardware), resource limitations of those virtual systems being well-defined and known. Thus, from the perspective of the systems designer, computer resource considerations are reduced to considerations of e.g. how many virtual computer systems of the cloud platform should be deployed; from the perspective of an operator of the platform itself (who may be different from the systems designer), computer resources are reduced to considerations of e.g. how many physical computer systems are needed to implement a required number of virtual machines having pre-defined resource allocations.

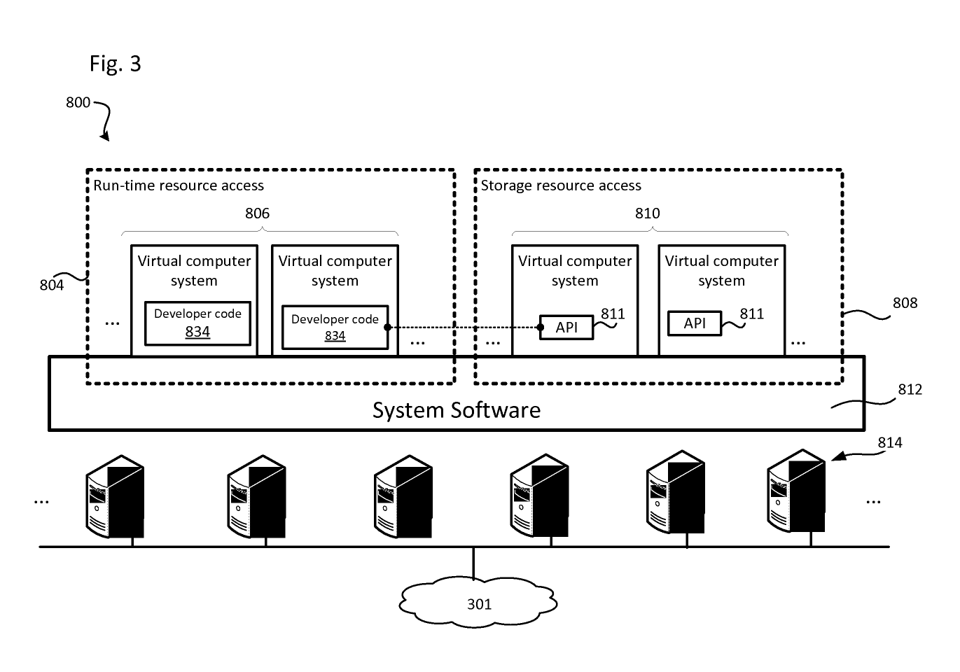

A high-level overview of an exemplary distributed platform 800 is shown in FIG. 3. The exemplary platform includes a distributed computer system 814. The computer system 814 of FIG. 3 is comprised of a very large number (e.g. tens of thousands) of networked computer devices—large enough that the physical computing resources can, in some contexts, be considered sufficiently plentiful as to be effectively unlimited. These computer devices are configured for communication with a packet-based data network 301 (e.g. the Internet) and are globally distributed (e.g. spread across multiple countries and/or continents). Typically, groups of such computer systems (e.g. thousands of servers) are housed in respective data centres (alternatively referred to as “datacentre”) at different geo-locations (i.e. in different regions of a country, different countries, different continents etc.)

System software 812 runs on top of the distributed computer system 814. The system software 812 is configured to implement two sets 804 (runtime set) and 808 (storage set) of independent, virtual, resource-limited computer systems 806, 810. Each virtual system 806, 810 is resource-limited in the sense that it is allocated a predetermined limited portion of the total available underlying physical resources of the distributed computer system 814 by the system software 812 and is independent in the sense that the size of this portion is substantially independent from other virtual systems of the platform 800. Each virtual system 806, 810 is virtual in the sense that it is software configured to emulate a computer architecture (which is typically different from that of the physical computer system 814).

The runtime set 804 comprises multiple virtual computer systems 806 which provide runtime environments for execution of application code 834, the application code 834 being executed on that virtual computer system 806. The system software 812 is configured to enable a software developer, desiring to make use of the platform 800, to upload their bespoke code 834 via network 301 to the platform 800 for execution thereon. In response, the system software 812 creates such a runtime environment and supplies the code 834 to the newly-created runtime environment for execution. Execution of this code 834 on the virtual system 806 is made possible by the system software mediating access to underlying physical processing resources and physical memory resources (primarily realized at the physical level by physical volatile memory) allocated to that environment.

The storage set 808 comprises multiple virtual computer systems 810 configured to provide data storage. Each has a corresponding Application Programming Interface (API) 811 which can be used to effect transfer of data to and from the physical memory resources (primarily realized at the physical level by physical non-volatile memory) allocated to that computer system 810 e.g. by code 834 making suitable function calls thereto. This transfer is, again, mediated by the system software 812.

Examples of distributed platforms include Windows Azure™, Amazon Web Services™ etc.

The analytics system is designed and implemented according to a set of principles and design patterns, with the core being that of generating suitable analytic data (for example data suitable for assisting the central control and decision making for a communications system). It comprises a plurality of service logics, each service logic being implemented by application code executed on one more virtual computer systems of the cloud platform, those virtual computer systems distinct from those of other service logics of the cloud platform (that is, such that different service logics are implemented by different sets of application code executed on different respective virtual computer systems of the could platform).

Service logics may be grouped according to type (there being multiple service logics of each type). Service logics may expose interfaces—e.g. RESTful (“Representational State Transfer”) interfaces—for communication with one another and/or with their respective agents. REST is an architectural style that abstracts architectural elements within a distributed hypermedia comprising, at a high level of abstraction, processing elements (i.e. elements which perform functions runtime—including service logics and service agents in the present context); data elements (i.e. data which is processed by processing elements—including real-time media communication event data and associated control data in this context); and connecting elements (i.e. mechanisms which facilitate communication between processing elements within the communication system in this context). REST ignores details of processing element implementation and protocol syntax in order to focus on the roles of processing elements, the constraints upon their interaction with other components, and their interpretation of significant data elements.

Services may be ‘bordered’ with different types of service logics having substantially disjoint remits (i.e. there is minimal or no overlap between tasks performed by different types of service logic): if control of a first service by a first type of service logic necessitates performance of a task that is within the remit of a second type of service logic, rather than perform that task itself, the service logic will request that a second service logic of that second type performs that task instead. Inter-service requests are higher-level requests in that they do not specify lower-level implementation details (that is, they request only that a particular task is completed without specifying lower-level details of how it is to be completed). The second service logic then informs the first service logic upon completion of that task, again without communicating any lower-level details of how it has been completed The first service logic can, once informed of the establishment of this mechanism, make use of that mechanism with the lower-level implementation details remaining largely invisible thereto.

Rules or ‘contracts’ are defined which, for each pair of service logics, specify circumstances in which that pair of service logics should and should not communicate directly with one other and which, for each service and its corresponding agent, specify circumstances in which that service and that agent should and should not communicate directly with one another. Contracts essentially define what each service exposes in terms of interfaces, what the responsibilities are, and what the limitations are.

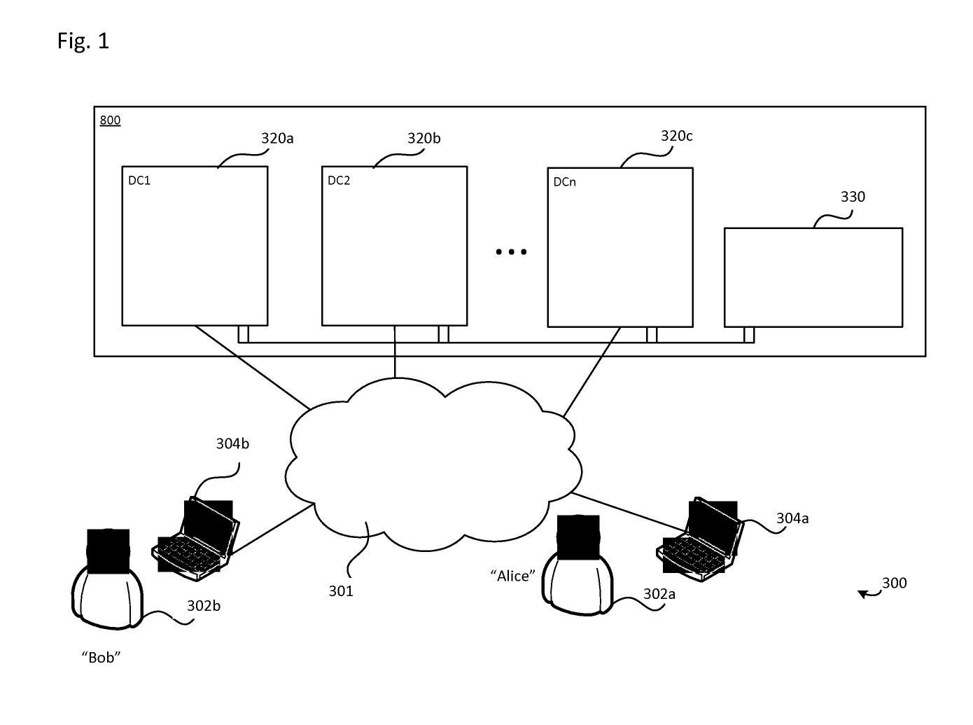

An example analytics system configured to monitor a communication system 800 in accordance with the present subject matter will now be described with reference to FIG. 1. The communication system 300 includes a packet-based communication network (here, a computer network) 301 (e.g. the Internet). Connected to the network 300 are a user device (user terminal) 304a associated with a first user 302a (“Alice”) and a further user device (user terminal) 204b associated with a second user 302b (“Bob”). The user devices 304a, 304b are arranged to receive information from and output information to the user of the respective device. Although only two user devices are shown in FIG. 1, many more user devices may be included in communication system 300. Each of the user devices 304a, 304b may be, for example, a mobile phone (e.g. smartphone), a tablet, a laptop, a personal computer (“PC”) (including, for example, Windows™, Mac OS™ and Linux™ PCs), a gaming device, a personal digital assistant (“PDA”) or other embedded device able to connect to the network 301.

Also connected to network 301 are a plurality of data centres (DCs) 320a, 320b, . . . , 320c performing as worker roles and an analytic role 330 forming part of the distributed platform 800.

The communication system 300 is for effecting communication events (e.g. AV calls) between a plurality of endpoints connected via the communication network 301. The endpoints may be user devices (e.g. 304a, 304b) and/or other computer devices/computer systems (e.g. servers or bridges). The communication system 300 may comprise a plurality of processing units each having access to computer storage holding executable (application) code modules for managing a communication event.

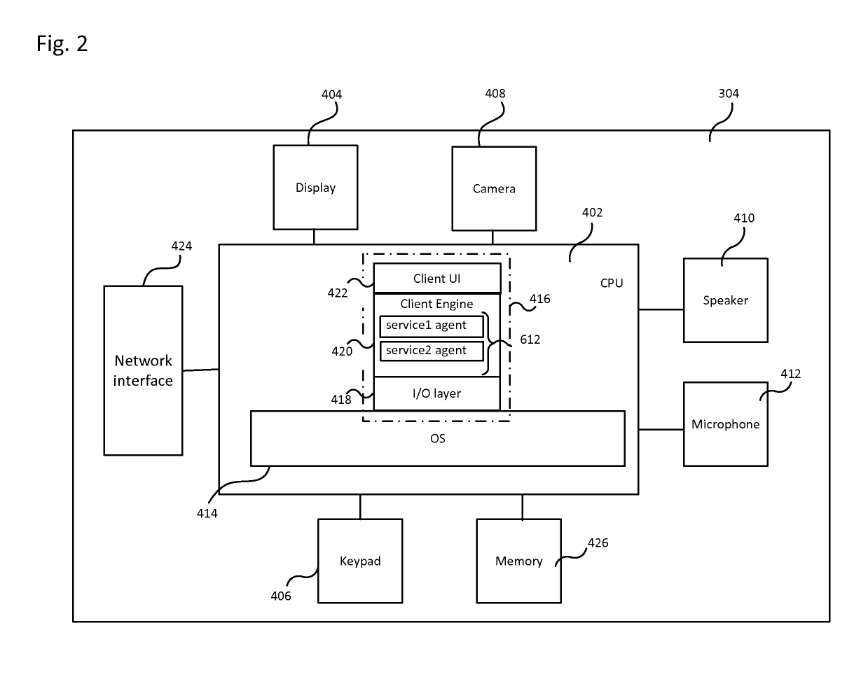

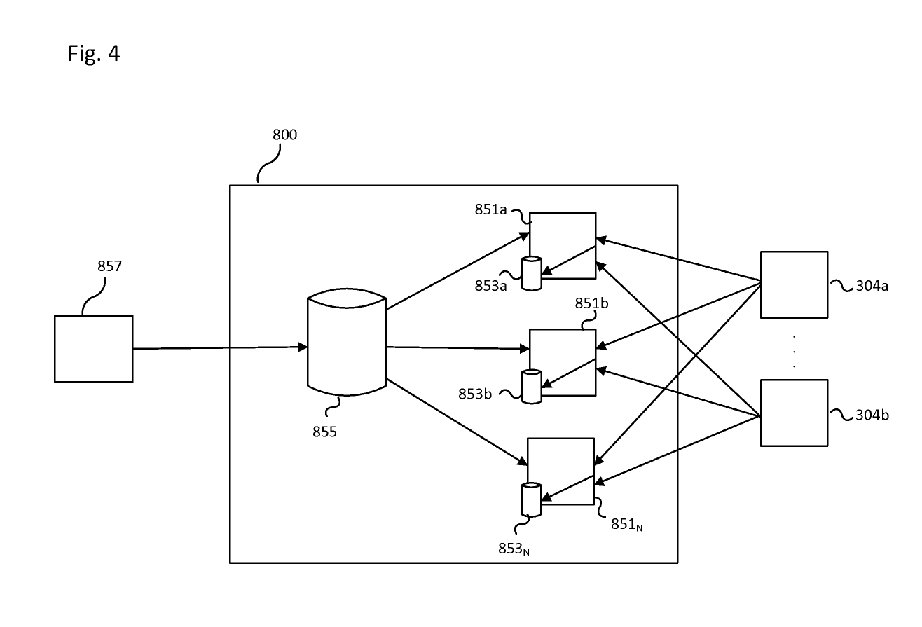

FIG. 2 illustrates a detailed view a user device 304 (such as user devices 304a and 304b). The user device 114 comprises a central processing unit (“CPU”) 402, to which is connected: output devices such as a display 404, which may be implemented as a touch-screen, and a speaker (or “loudspeaker”) 410 for outputting audio signals; input devices such as a microphone 426 for receiving audio signals, a camera 408 for receiving image data, and a keypad 406; a memory 426 for storing data; and a network interface 424 such as a modem for communication with the network 301. The user device 114 may comprise other elements than those shown in FIG. 4. The display 404, speaker 410, microphone 412, memory 426, camera 408, keypad 406 and network interface 424 are be integrated into the user device 304. Alternatively, one or more of the display 404, speaker 410, microphone 412, memory 426, camera 408, keypad 406 and network interface 424 may not be integrated into the user device and may be connected to the CPU 402 via respective interfaces. One example of such an interface is a USB interface. If the connection of the user device 304 to the network 301 via the network interface 424 is a wireless connection then the network interface 424 may include an antenna for wirelessly transmitting signals to the internet 301 and wirelessly receiving signals from the internet 301.

FIG. 2 also illustrates an operating system (“OS”) 414 executed on the CPU 402. Running on top of the OS 414 is an instance of a communication client 416 application (client) of the communication system 300, shown as a software stack. The client 416 communicates with the operating system 414 and manages the connections over the communication system 300, including connections with other user devices and with datacentres 320. The client 416 has a client User Interface (“UI”) which is used to present information to, and receive information from, a user of the device. In this way, the client 416 performs the processing required to allow a user (e.g. Alice, Bob) to communicate over the communication system 300. The software stack shows a client protocol layer 418, a client engine layer 420 and a client user interface layer 422. Each layer is responsible for specific functions. Because each layer usually communicates with two other layers, they are regarded as being arranged in a stack as shown in FIG. 2. The operating system 414 manages hardware resources of the device 304 and handles data being transmitted to and from the network 301 via the network interface 424. The client protocol layer 418 of the client software communicates with the operating system 414 and manages the connections over the communication system 300. Processes requiring higher level processing are passed to the client engine layer 420. The client engine 420 also communicates with the client user interface layer 422. The client engine 420 is arranged to control the client user interface layer 334 to present information to the user via the user interface of the client and to receive information from the user via the user interface.

The client engine layer comprises a plurality of service agents 421. Each service agent handles a distinct aspect of a real-time media communication event (e.g. call); the plurality of service agents cumulatively enable a user to conduct such a real-time media communication event via the client user interface. Each service agent has a corresponding API (e.g. C++ API) and the agents communicate with one another by way of those APIs. An agent is the endpoint/client logic implementation that defines how that endpoint interacts with each service (and sometimes with each other).

With respect to FIG. 4 an example of a pull analytics system architecture is shown. The pull analytics system architecture is shown implemented on a distributed platform 800 such as shown above. In the example shown in FIG. 4 the example architecture shows the scalable worker roles 851 which are configured to receive data from the client applications in the form of user devices 304. Each of the scalable worker roles 851 may be associated with a local memory or database 853. Thus a first worker role 851a is associated with a first local memory or database 853a, a second worker role 851b is associated with a second local memory or database 853b, and a n'th worker role 851n is associated with a n'th local memory or database 853n.

Furthermore the example pull analytics system architecture as shown in FIG. 4 may comprise an analytics role or application 855. The analytics role or application 855 may be configured to accept an external request in the form of an HTTPS request with authentication certificate. The external request may be from a developer or operation manager 857 requesting information from the analytics role 855. The analytics role 855 may be configured to communicate with the worker roles 851. In some embodiments the analytics role 855 may be configured to generate an internal HTTP request to each of the worker roles 851. The worker roles 851 may furthermore be configured to accept the HTTP request from the analytical role 855. The worker roles having received the request may be configured to lock the local memory or database 853. This locking of the local memory or database is performed as the database is single threaded to prevent overwriting data causing errors. In such situations the locking of the local memory or the database 853 means that the worker role 851 becomes unresponsive to client application data during this lock. In other words when the database is locked no data passed to the associated worker role from a client application will be received and may be lost.

The worker role 851 having received the HTTP request from the analytics role 855 may be configured to examine the HTTP request and execute the query within the HTTP request. For example the request may comprise a SQL or similar database command, such as select * from . . . , which may be executed and used to extract data from associated local memory or database.

The worker role 851 may be configured to convert the returned data (such as a SQLite result) into a suitable string with probable proper escaping.

These worker role 851 may then be further configured to encapsulate any generated strings into a form suitable for outputting to the analytics role 855. For example the worker role 851 may be configured to generate an Extensible Markup Language (XML) format to generate the data stream to be passed from the worker role 851 to the analytics role 855.

The worker role 851 may furthermore be configured to stream or pass the response from the worker role 851 to the analytics role 855.

The worker role 851 may the furthermore be configured to unlock the internal memory or database 853 to enable further client application data to be received and stored and therefore becomes responsive again.

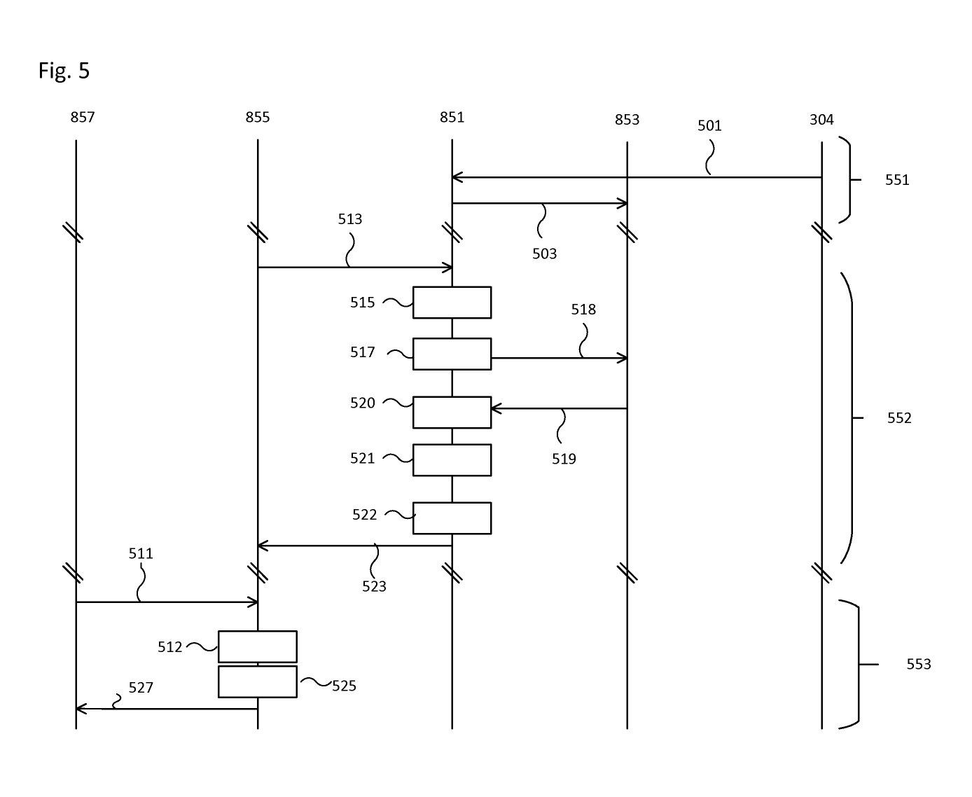

With respect to FIG. 5 the operations or methods performed by the pull analytics system 800 shown in FIG. 4 are shown in further detail.

The first part 551 of FIG. 5, shows the steps or operations prior to the generation/receipt of an analytics request. These prior or ‘pre’ operations are those describing interactions between the client application (such as the user device 304) the worker role 851 and the internal memory or database 853.

The client application, such as the user device 304 may for example be configured to generate information about the communications client, for example the response times of communications between the users and between a user and servers (DCs).

This information may be passed or transmitted to the worker roles 851.

The operation of transmitting the client application information from the client application, such as executed on the user device 304, to the worker role 851 is shown in FIG. 5 by step 501.

The worker role 851 may, as described herein, be configured to receive this information and store it in the associated memory or database 853.

The operation of storing the client application information in the associated memory or database is shown in FIG. 5 by step 503.

These operations may be repeated for any information passed to a worker role 851 from a client application, such as a user device 304.

The second part 552 of FIG. 5, shows the steps or operations associated with the pulling of data by the analytics role 855.

The analytics role 855 may thus furthermore pull data from individual instances in the background periodically (with some time intervals which are configurable).

The analytics role 855 may pull this data so it has “fresh” copy of data.

The pull or internal request may comprise a query (for example a SQL query) requesting data from the worker role 851. The analytics role 855 may furthermore transmit the internal request to at least one worker role 851.

The operation of generating and transmitting an internal request is shown in FIG. 5 by step 513.

The worker role 851 may be configured to receive the internal request. Furthermore the worker role 851 on receiving the internal request may be configured to lock the associated internal memory of database 853 from any external access. In other words the worker role becomes unresponsive to any new external requests from the client application, in the form of messages from the user device 304.

The operation of receiving the internal request and locking the database or associated internal memory is shown in FIG. 5 by step 515.

The worker role 851 may furthermore be configured to retrieve from the internal request the query and execute the query on the associated internal memory or database 853.

The operation of retrieving the query is shown in FIG. 5 by step 517.

The operation of accessing the database with the query is shown in FIG. 5 by step 518.

The operation of receiving a response to the query from the database is shown in FIG. 5 by step 519.

The worker role 851 may furthermore be configured to convert the database response, which may be in a SQLite result object format into a suitable string format.

The operation of converting the response format into a string format is shown in FIG. 5 by step 520.

Furthermore the worker role 851 having generated string format response may be further configured to concatenate the strings to generate a single format such as XML.

The operation of concatenating the strings and generating a suitable format is shown in FIG. 5 by step 521.

In some embodiments the worker role 853 may then be configured to unlock the associated internal memory of database 853 from any external access. In other words the worker role becomes responsive to any new external requests from the client application, in the form of messages from the user device 304.

The operation of unlocking the database is shown in FIG. 5 by step 522.

The worker role 853 can be configured to stream the concatenated response to the analytics role 855.

The operation of streaming or transmitting the response to the internal request from the worker role 853 to the analytics role 855 is shown in FIG. 5 by step 523.

The third part 553 of FIG. 5 shows the steps or operations associated with the generation/receipt of an analytics request. These operations are those describing interactions between the external requester, such as the developer 857, and the analytics role 855.

The external requester, which in this example is the developer or operations manager 857, may be configured to generate an external HTTPS request. The HTTPS request may further be associated with an authentication certificate identifying the requester. The external request may comprise a request for specific information from the analytics role 855.

The operation of generating and transmitting from the external requestor 857 (and receiving at the analytics role 855) the HTTPS request is shown in FIG. 5 by step 511.

The analytics role 855 may be configured to receive the HTTPS request and authentication certificate. In some embodiments the analytics role may be configured to authenticate the request.

The operation of authenticating the request is shown in FIG. 5 by step 512.

The analytics role 855 may then be configured to process the pulled responses from the worker role 851 and process this responses, and other pulled responses from other worker roles in order to generate a response to the external request.

The operation of generating a response to the external request is shown in FIG. 5 by step 525.

The analytics role 855 may furthermore be configured to transmit the response to the external requestor 857.

The operation of transmitting the response to the external request is shown in FIG. 5 by step 527.

The analytics system pull example as shown above however has several problems. Firstly the number of operations between receiving the external request and the transmission of the response to the external request means that the response is not real time or even a near-real time response. Furthermore because of the need to lock the database associated with the worker role in order to execute the query on the database, and causing the worker role to become unresponsive to any further external requests from client applications, then there is the possibility of data being lost from the client application and the worker role.

The concept behind embodiments of the application is to attempt to reduce these problems by configuring the analytics system such that it is able to operate in a push mode.

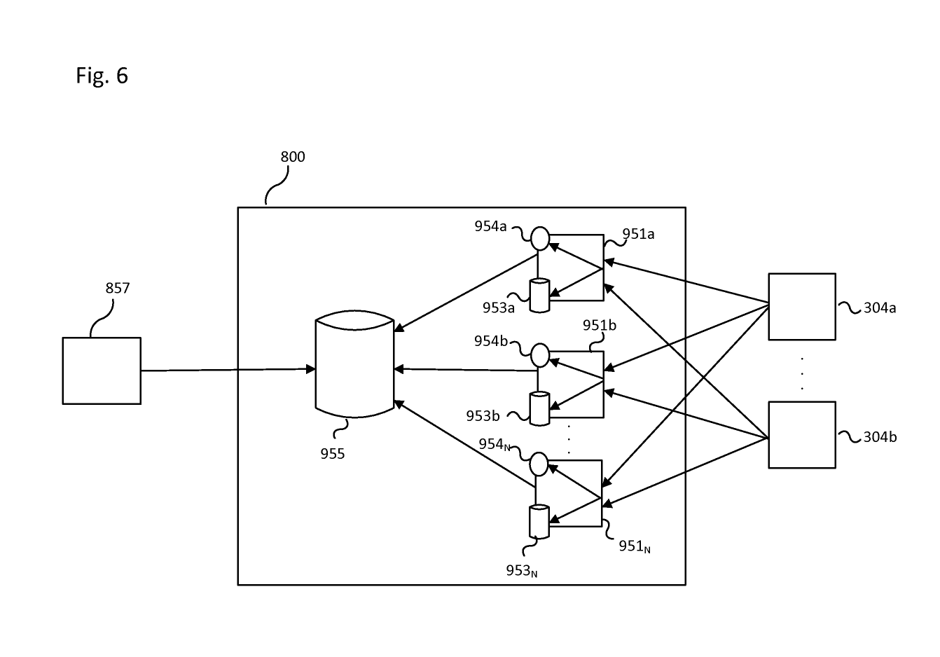

With respect to FIG. 6 an analytics system architecture suitable for implementing a push mode of operation is shown. The push analytics system architecture is shown implemented on a distributed platform 800 such as shown above. In the example shown in FIG. 6 the example architecture shows the scalable worker roles 951 which are configured to receive data from the client applications in the form of user devices 304. Each of the scalable worker roles 951 may be associated with a local memory or database 953. Furthermore each of the scalable worker roles 951 may be associated with a memory queue 954. Thus a first worker role 951a is associated with a first local memory or database 953a and a first memory queue 954a, a second worker role 951b is associated with a second local memory or database 953b and a second memory queue 954b, and a n'th worker role 951n is associated with a n'th local memory or database 953n and a n'th memory queue 954n. The worker roles 951 may be configured to receive the data from the client applications, for example information on communication requests, response times etc and store a copy of the data in both the associated local memory 953 and also in the memory queue 954.

The worker role 951 and/or memory queue 954 may be configured such that when the memory queue 954 reaches a defined ‘fill’ level or after a defined time period (for example following an earlier data transmission or a first queued data element) then data within the memory queue 954 is transmitted or streamed to the analytics role 955.

Furthermore the example push analytics system architecture as shown in FIG. 6 may comprise an analytics role or application 955. The analytics role or application 955 may be configured to accept an external request in the form of an HTTPS request with authentication certificate. The external request may be from a developer or operation manager 857 requesting information from the analytics role 955.

The analytics role 955 may be configured to communicate with the worker roles 951 in that the worker role 951 is configured to output the contents of the memory queue 954 to the analytics role 955.

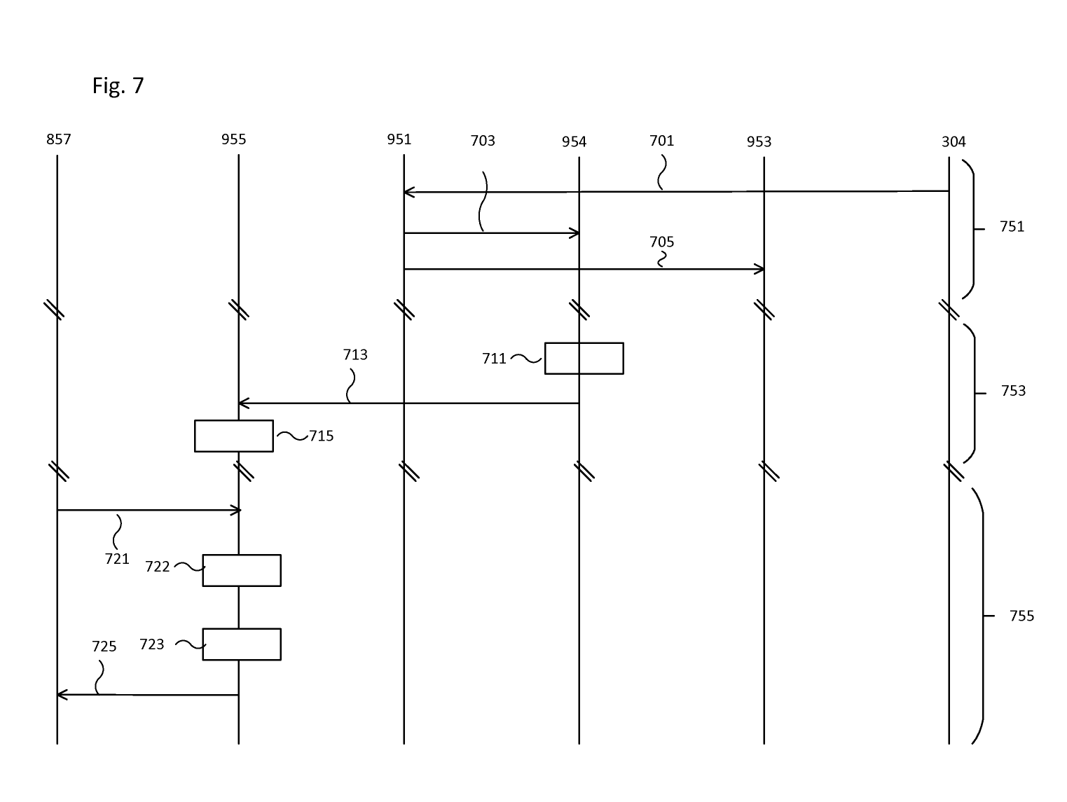

With respect to FIG. 7 the operations or methods performed by the push analytics system 800 shown in FIG. 6 are shown in further detail.

The first part 751 of FIG. 7, shows the steps or operations describing interactions between the client application (such as the user device 304) the worker role 951, the internal memory or database 953 and the memory queue 954.

The client application, such as the user device 304 may for example be configured to generate information about the communications client, for example the response times of communications between the users.

This information may be passed or transmitted to the worker roles 951.

The operation of transmitting the client application information from the client application, such as executed on the user device 304 to the worker role 951 is shown in FIG. 7 by step 701.

The worker role 951 may, as described herein, be configured to receive this information and store it in the associated memory or database 953.

The operation of storing the client application information in the associated memory or database is shown in FIG. 7 by step 705.

The worker role 951 may be further configured to store this information in the associated memory queue 954. In some embodiments the data or information is converted or transformed into a data format, for example an XML format suitable to be passed to the analytics role, prior to being stored in the memory queue 954.

The operation of storing the client application information in the associated memory queue 954 is shown in FIG. 7 by step 703.

These operations may be repeated for any information passed to a worker role 951 from a client application, such as a user device 304.

The second part 753 of FIG. 7 shows the steps or operations associated with the push mechanism from the worker role 951/memory queue 954 and the analytics role 955.

These operations are those describing interactions from the worker role 951 (and the contents of the memory queue 954) and the analytics role 955.

The memory queue 954 (or in some embodiments the worker role 951) may be configured to monitor the fill level of the memory queue 954 and be configured to initiate a data transfer operation when a determined level is reached. In some embodiments the memory queue 954 (or the worker role 951) may be configured to monitor a time period from the last data transfer operation or from a time stamp associated with data stored in the memory queue 954 and initiate a data transfer operation when the time period is greater than a determined threshold value. In other words the memory queue 954 or the worker role 951 may be configured to determine a trigger event (which may be memory fill or time based) and initiate a data transfer or push event based on the determination of the trigger event.

The initiation of the data transfer or push operation may for example be achieved by an exchange of messages between the worker role 951 and the analytics role 955. For example the worker role 951 may generate and transmit to the analytics role 955 a request message, the request message indicating that the worker role 951 is to transmit to the analytics role 955 the push message. The analytics role 955 may in some embodiments respond to the request message indicating that the analytics role 955 can accept the push message.

The initiation of the data transfer or push operation is shown in FIG. 7 by step 711.

The memory queue 954 or the worker role 951 may then transfer the data from the memory queue 954 to the analytics role 955.

The data transfer or push operation whereby data from the memory queue 954 is transmitted or streamed to the analytics role 955 is shown in FIG. 7 by step 713.

The analytics role 955 may be configured to receive the data transfer or push message from the memory queue 954 or worker role 951. Furthermore in some embodiments the data transfer or push message may be stored in a memory associated with the analytics role 955.

The operation of storing the data storage or push message at the analytics role 955 is shown in FIG. 7 by step 715.

The third part 755 of FIG. 7 shows the steps or operations associated with the generation/receipt of an external analytics request. These operations are those describing interactions between the external requester, such as the developer 857 and the analytics role 955.

The external requester, which in this example is the developer or operations manager 857, may be configured to generate an external HTTPS request. The HTTPS request may further be associated with an authentication certificate identifying the requester. The external request may comprise a request for specific information from the analytics role 955.

The operation of generating and transmitting from the external requestor 857 (and receiving at the analytics role 955) the HTTPS request is shown in FIG. 7 by step 721.

The analytics role 955 may be configured to receive the HTTPS request and authentication certificate. In some embodiments the analytics role may be configured to authenticate the request.

The operation of authenticating the request is shown in FIG. 7 by step 722.

The analytics role 955 may furthermore process the request and execute the query on the stored push messages.

The operation of executing the query on the push messages is shown in FIG. 7 by step 723.

Following the execution of the query the analytics role 955 may be configured to generate a response to the external request using the response to executing the query. The response to the external request may be transmitted to the external requestor.

The operation of transmitting the response to the external request is shown in FIG. 7 by step 725.

The push architecture and methods shown and described herein may thus overcome or mitigate the problems discussed above.

For example the worker role in the push architecture does not lock the local memory or database and thus the possibility of losing data between the client application and the analytics role is removed. The application of real-time data thus means that data in the Analytics role is as fresh as possible, as compared to the pull architecture example where it could become stale due to population process and reading entire local DB in small chunks which might take long time.

Thus for example in the pull example (such as shown in figured 4 and 5) the analytics role reads a small portion of data at a time, then it requests next portion etc. (in background) until end of DB is reached. Then the process is started again from beginning. Thus a reason for data to be lost in Analytics role in the pull example is that the data may be erased from individual instances while the Analytics role reads the entire DB. In other words data may be lost between full iterations of the read process when it restarts reading DB from beginning as new data could be inserted by client into individual instance, then it gets deleted from individual instance as it becomes stale, so Analytics role does not see it, and thus this data is lost from aggregation.

Furthermore data may be lost in an individual instance during DB lock when the instance is unresponsive.

In some embodiments the analytics role may furthermore be configured to perform load balancing operations. For example in response to the request message indicating that the worker role 951 is to transmit to the analytics role 955 the push message, the analytics role 955 may determine whether there is capacity at the analytics role 955. When the analytics role 955 determines that there is capacity for receiving the push message then the analytics role may generate a positive response message and the worker role 951 on receiving the positive response start to transmit or stream the push message. However when the analytics role 955 determines that there is no capacity for receiving the push message then the analytics role may generate a negative response message and the worker role 951 on receiving the negative response pause or stop the transmission or streaming of the push message. In such embodiments therefore the data is not lost but remains on the memory queue 954 until a further request is responded to positively.

Furthermore in some embodiments the load balancing may be assisted by the worker role 951. As described herein the trigger event which initialises the transmission or streaming of the push message may be set according to a fill or capacity level of the memory queue 954 or set based on a time period measured from a defined event such as the last streamed or transmitted push message or data stored in the memory. In some embodiments the trigger event may be adjustable or variable and be set based on capacity messages or response messages from the analytics role 955 such that the push data message streaming or transmission is controlled in order to prevent an overloading of the analytics system.

In one aspect there is an analytics system for aggregating data in a distributed computing platform, the analytics system comprising: a plurality of worker roles configured to receive and process information from client applications, each worker role having access to an associated memory for storing the information from client applications, wherein each worker role is further configured to push the stored information from client applications stored within the associated memory to an analytics role; at least one analytics role configured to receive the pushed stored information and furthermore configured to receive and respond to a request based on the pushed stored information.

Each worker role may be further configured to have access to a database memory for storing the information from client applications, wherein the database memory may be configured to be accessible to the worker role for processing the information from client applications.

The worker role may be configured to monitor the associated memory and determine a trigger event for initialising the pushing of the stored information stored within the associated memory to the analytics role.

The trigger event may be a capacity level of the associated memory.

The trigger event may be a time period following a determined event.

The worker role configured to initialise the pushing of the stored information may be configured to: generate a push request message for the at least one analytics role; and control the pushing the stored information based on a response to the push request from the at least one analytics role.

The worker role configured to control the pushing the stored information based on a response to the push request from the at least one analytics role may be configured to push the stored information based on a positive response to the push request from the at least one analytics role.

The worker role configured to control the pushing the stored information based on a response to the push request from the at least one analytics role may be configured to pause the push of the stored information based on a negative response to the push request from the at least one analytics role.

The worker role may be configured to define the trigger event based on the response to the push request from the at least one analytics role.

The analytics role may be configured to generate the response to the push request based on a determined capacity of the analytics role.

According to a second aspect there is an apparatus comprising: at least one processor; and a memory comprising worker role code, the worker code, when executed on the at least one processor, causes the apparatus to: receive and process information from client applications; access an associated memory for storing the information from client applications; and push the stored information from client applications stored within the associated memory to an analytics role; and a memory comprising analytics role code, the analytics role code, when executed on the at least one processor, causes the apparatus to receive the pushed stored information; and receive and respond to a request based on the pushed stored information.

The worker role code may be further caused to access a database memory for storing the information from client applications, wherein the database memory may be configured to be accessible to the worker role code for processing the information from client applications.

The worker role code may be further caused to monitor the associated memory and determine a trigger event for initialising the pushing of the stored information stored within the associated memory to the analytics role code.

The trigger event may be a capacity level of the associated memory.

The trigger event may be a time period following a determined event.

The worker role code caused to initialise the pushing of the stored information may be further caused to: generate a push request message for the at least one analytics role; and control the pushing the stored information based on a response to the push request from the at least one analytics role.

The worker role code caused to control the pushing the stored information based on a response to the push request from the at least one analytics role may be caused to push the stored information based on a positive response to the push request from the at least one analytics role.

The worker role code caused to control the pushing the stored information based on a response to the push request from the at least one analytics role may be further caused to pause the push of the stored information based on a negative response to the push request from the at least one analytics role.

The worker role code may be caused to define the trigger event based on the response to the push request from the at least one analytics role.

The analytics role code may be caused to generate the response to the push request based on a determined capacity of the analytics role.

According to a third aspect there is a method for aggregating data in a distributed computing platform, the method comprising: receiving and processing information from client applications at a plurality of worker roles; storing the information from client applications on an associated memory; pushing the stored information from client applications stored within the associated memory to an analytics role; receiving the pushed stored information at at least one analytics role; and receiving and responding to a request based on the pushed stored information.

The method may further comprise storing the information from client applications at a database memory, wherein the database memory is accessible to the worker role for processing the information from client applications.

The method may further comprise monitoring the associated memory and determining a trigger event for initialising the pushing of the stored information stored within the associated memory to the analytics role.

Initialising the pushing of the stored information may comprise: generating a push request message for the at least one analytics role; and controlling the pushing the stored information based on a response to the push request from the at least one analytics role.

Controlling the pushing of the stored information based on a response to the push request from the at least one analytics role may comprise pushing the stored information based on a positive response to the push request from the at least one analytics role.

Controlling the pushing the stored information based on a response to the push request from the at least one analytics role may comprise pausing the pushing of the stored information based on a negative response to the push request from the at least one analytics role.

The method may comprise defining the trigger event based on the response to the push request from the at least one analytics role.

The method may comprise generating the response to the push request based on a determined capacity of the analytics role.

Whilst in the above, the processing units of the communication system on which controllers are instantiated are remote from call endpoints (that is the processing units are processing units other than said endpoints), in alternative embodiments some control may still be effected by the endpoints (that is by controller code on the endpoints). For example, in one embodiment call control, audio control, media control, transport control and pipe control may all be implemented centrally in the could 800 as described above, whilst e.g. instant messaging control is implemented on the endpoints themselves (and not by a cloud control service logic).

Further, whilst in the above, variously configured agents (call, media, transport, pipe) are implemented by a user device, in other embodiments endpoint other than user devices (e.g. servers, bridges etc.) may implemented one or more of the described agents.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user devices may also include an entity (e.g. software) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An analytics system for aggregating data in a distributed computing platform, the analytics system comprising:
a plurality of worker roles configured to receive and process information from client applications, each worker role having access to an associated memory for storing the information from client applications, wherein each worker role is further configured to push the stored information from client applications stored within the associated memory to an analytics role;
at least one analytics role configured to receive the pushed stored information and furthermore configured to receive and respond to a request based on the pushed stored information.

2. The analytics system of claim 1, each worker role is further configured to have access to a database memory for storing the information from client applications, wherein the database memory is configured to be accessible to the worker role for processing the information from client applications.

3. The analytics system of claim 1, wherein the worker role is configured to monitor the associated memory and determine a trigger event for initialising the pushing of the stored information stored within the associated memory to the analytics role.

4. The analytics system of claim 3, wherein the trigger event is a capacity level of the associated memory.

5. The analytics system of claim 3, wherein the trigger event is a time period following a determined event.

6. The analytics system of claim 3, wherein the worker role configured to initialise the pushing of the stored information is configured to:
generate a push request message for the at least one analytics role; and
control the pushing the stored information based on a response to the push request from the at least one analytics role.

7. The analytics system of claim 6, wherein the worker role configured to control the pushing the stored information based on a response to the push request from the at least one analytics role is configured to push the stored information based on a positive response to the push request from the at least one analytics role.

8. The analytics system of claim 6, wherein the worker role configured to control the pushing the stored information based on a response to the push request from the at least one analytics role is configured to pause the push of the stored information based on a negative response to the push request from the at least one analytics role.

9. The analytics system of claim 6, wherein the worker role is configured to define the trigger event based on the response to the push request from the at least one analytics role.

10. The analytics system of claim 9, wherein the analytics role is configured to generate the response to the push request based on a determined capacity of the analytics role.

11. An apparatus comprising:
at least one processor; and
a memory comprising worker role code, the worker code, when executed on the at least one processor, causes the apparatus to:
receive and process information from client applications;
access an associated memory for storing the information from client applications; and
push the stored information from client applications stored within the associated memory to an analytics role; and
a memory comprising analytics role code, the analytics role code, when executed on the at least one processor, causes the apparatus to
receive the pushed stored information; and
receive and respond to a request based on the pushed stored information.

12. The apparatus of claim 11, wherein the worker role code is further caused to access a database memory for storing the information from client applications, wherein the database memory is configured to be accessible to the worker role code for processing the information from client applications.

13. The apparatus of claim 11, wherein the worker role code is further caused to monitor the associated memory and determine a trigger event for initialising the pushing of the stored information stored within the associated memory to the analytics role code.

14. The apparatus of claim 13, wherein the trigger event is a capacity level of the associated memory.

15. The apparatus of claim 13, wherein the trigger event is a time period following a determined event.

16. A method for aggregating data in a distributed computing platform, the method comprising:
receiving and processing information from client applications at a plurality of worker roles;
storing the information from client applications on an associated memory;
pushing the stored information from client applications stored within the associated memory to an analytics role;
receiving the pushed stored information at at least one analytics role; and
receiving and responding to a request based on the pushed stored information.

17. The method of claim 16, further comprising storing the information from client applications at a database memory, wherein the database memory is accessible to the worker role for processing the information from client applications.

18. The method of claim 16, further comprising monitoring the associated memory and determining a trigger event for initialising the pushing of the stored information stored within the associated memory to the analytics role.

19. The method of claim 18, wherein the trigger event is a capacity level of the associated memory.

20. The method of claim 18, wherein the trigger event is a time period following a determined event.
